(19) United States
(12) Patent Application Publication
(10) Pub. No.: US 2015/0329433 A1
(43) Pub. Date: Nov. 19, 2015

(54) ENVIRONMENT-FRIENDLY SLOW-RELEASE SULFUR-BASED NITROGEN POTASSIUM COMPOUND FERTILIZER

(71) Applicants: Qinghuai LV, Linyi City, Shandong Province (CN); SHIKEFENG CHEMICAL INDUSTRY CO., LTD., Linyi City, Shandong Province (CN)

(72) Inventors: Qinghuai LV, Linyi (CN); Ruixin LV, Linyi (CN); Mingsheng SHAO, Linyi (CN); Junhua GONG, Linyi (CN); Xiaodong LU, Linyi (CN); Yongqiang ZHAO, Linyi (CN)

(73) Assignees: SHIKEFENG CHEMICAL INDUSTRY CO., LTD, Linyi (CN); Qinghuai LV, Linyi (CN)

(21) Appl. No.: 14/758,159

(22) PCT Filed: Oct. 14, 2013
(86) PCT No.: PCT/CN2013/001244

§ 371 Date: Jun. 26, 2015

(30) Foreign Application Priority Data
Dec. 26, 2012 (CN) 201210574343.X

(51) Int. Cl. C05C 3/00; C05B 17/00; C05G 3/00

(52) U.S. Cl. CPC C05C 3/005; C05G 3/0041; C05B 17/00

(57) ABSTRACT

Provided is an environment-friendly slow-release sulfur-based nitrogen potassium compound fertilizer. The preparation includes first preparing sulfur-based nitrogen potassium compound fertilizer granules, and then conducting primary coating of stearic acid and secondary surface powder dusting of modified zeolite powder on the sulfur-based nitrogen potassium compound fertilizer granules, to obtain the slow-release sulfur-based nitrogen potassium compound fertilizer. The sulfur-based nitrogen potassium compound fertilizer granules are prepared from the following raw materials in parts by weight: 31 to 57 parts of urea, 10 to 20 parts of ammonium sulfate, 20 to 50 parts of potassium sulfate, 6 to 12 parts of a granulating auxiliary agent, and a proper amount of water.

### FIELD OF THE DISCLOSURE

The present disclosure relates to an environment-friendly slow-release sulfur-based nitrogen potassium compound fertilizer, belonging to mixed fertilizers containing substances influencing nitrification of ammonium compounds or urea in soil.

### BACKGROUND

The compound fertilizers comprising chloride ion with a content of more than 3% are referred to as chlorine-based compound fertilizers. Compared to sulfur-based fertilizer, the chlorine-based fertilizer is manufactured in low cost, and also sold at a price significantly lower than that of sulfur-based fertilizer. However, due to negative impacts of the chlorine-based compound fertilizers on growth of some fear-chlorion crops, chlorine-containing fertilizers, such as potassium chloride, ammonium chloride, are avoided to apply to saline-alkali soil and fear-chlorion crops. The chlorine ions in chlorine-containing fertilizers would be retained and accumulated in soil, resulting in soil acidification, thus the application thereof to saline-alkali soil would aggravate the salt injury; the application thereof to fear-chlorion crops would affect the yield and quality of the latter. Therefore, the scope of application of the chlorine-based compound fertilizers is limited.

Sulfur element, in the sulfur-based compound fertilizer, is the fourth essential nutrient for the growth of crops, just following nitrogen, chlorine, and potassium. The chloride ions with a content of <3% can effectively ameliorate the condition of sulfur-deficiency in soil, and directly provide sulfur for crops as nutrients. The sulfur-based compound fertilizers, with respect to crops and soil, are of strong adaptability and wide scope of application, and thus can be used as basic fertilizer, additional fertilizer, seed fertilizer and foliage fertilizer. The sulfur-based compound fertilizers can effectively enhance both the yield of crops and the quality of agricultural products, hence they are widely administered.

The producing process of sulfur-based compound fertilizers is complicated, accompanied with high energy consumption, corrosion of equipment, and waste of resources, resulting in high manufacturing cost and environmental pollution.

Urea is a kind of high-quality nitrogen fertilizer, which is with a high amount of nitrogen, of immediate fertilizer efficiency, and of large consumption. However, during the procedure of application, urea is prone to lose via volatilization, leaching, degradation, runoff and other ways, resulting in low fertilizer availability. According to the statistics, the fertilizer availability in the current quarter is only about 30%, which not only results in the waste of fertilizer, but also causes pollutions of environments such as air, water and soil that human beings need. The nutrient availability of sulfur-based compound fertilizers in the prior art only ranges from 25% to 35%, wherein the availability of nitrogen fertilizers is less than 30%, representing a particularly serious loss.

Disclosed in Chinese Patent Application CN 201110258810.3 is a tower granulated, slow-release, and long-term sulfur-based compound fertilizer with a high amount of nitrogen and preparation method. It is prepared by means of the following procedures: firstly, tower granulated urea compound fertilizer granules are prepared by using tower granulation apparatus, primary coating of paraffin and secondary surface coating of modified zeolite powder are then conducted on the urea compound fertilizer granules. The deficiencies thereof are characterized in that the investment cost of such tower granulation apparatus is high, and in that paraffin is a kind of non-renewable fossil resources and resistant to degradation in soil. The tower granulated compound fertilizer products manufactured by using the aforesaid preparation process show poor performances in release.

In coating controlled-release fertilizer, endoplasmic type controlled-release fertilizer, stable controlled-release fertilizer, and biological inhibitor type controlled-release fertilizer in the prior art, sulfur or synthetic resin usually plays a role as coating slow-release material, wherein the sulfur coating is easily broken, and is prone to bring toxic effects to rice and other crops. The resin coating is costly and resistant to degradation in soil.

Environment-friendly slow-release sulfur-based nitrogen potassium compound fertilizer is still not common in the prior art.

### SUMMARY

The purpose of the present disclosure is to avoid the aforementioned deficiencies in the prior art, and thus to provide an environment-friendly slow-release sulfur-based nitrogen potassium compound fertilizer, which exhibits a good slow-release effect, high fertilizer availability, and a wide scope of application, whereas only needs a simple and low-cost producing process, the coating material of which is easily degraded by microorganisms in soil, and which is beneficial for the environmental protection of soil, air and water.

The purpose of the present disclosure can be achieved by the following solutions:

An environment-friendly slow-release nitrogen potassium sulfur-based compound fertilizer of the present disclosure, characterized in that it is prepared by means of the following procedures: firstly, sulfur-based nitrogen potassium compound fertilizer granules are prepared, primary coating of stearic acid and secondary surface dusting of modified zeolite powder are then conducted on the sulfur-based nitrogen potassium compound fertilizer granules, wherein said sulfur-based nitrogen potassium compound fertilizer granules are made from the following raw materials in parts by weight:

| | |
|---|---|
| Urea | 31~57 |
| Ammonium sulfate | 10~20 |
| Potassium sulfate | 20~50 |
| Granulating adjuvant | 6~12 |
| Water | Q.S. |

said granulating adjuvant is prepared by mixing 50%˜75% of bentonite and 50%˜25% of powdered bauxite;
said stearic acid is primarily coated, the amount of stearic acid accounts for 0.6%˜1.2% by weight of sulfur-based nitrogen potassium compound fertilizer granule;
said modified zeolite powder is composed of the following raw materials in parts by weight:

| | |
|---|---|
| Magnesium stearate | 1.5%~.3.0% |
| Zeolite powder | 97%~98.5% |

the preparation method thereof comprises the following steps:
\textcircled{1}. preparation of sulfur-based nitrogen potassium compound fertilizer granules
firstly, 31˜57 parts by weight of urea is heated to a molten state, 10˜20 parts by weight of ammonium sulfate and 20˜50 parts by weight of potassium sulfate are added thereinto and well mixed, 6˜12 parts by weight of granulating adjuvant and appropriate amount of water are added thereinto, various components of the compound fertilizer are mixed and granulated by using conventional granulator to afford granules for further steps;
\textcircled{2}. primary coating of stearic acid
the amount of stearic acid accounts for 0.6%˜1.2% by weight of the sulfur-based nitrogen potassium compound fertilizer granules prepared in step \textcircled{1}, the coating process is as follows:
a. preparation of molten stearic acid
the stearic acid for coating is accurately metered according to the formula, added into melting bath for stearic acid, and heated to a molten state to afford molten stearic acid for further steps;
b. coating
the sulfur-based nitrogen potassium compound fertilizer granules prepared in step \textcircled{1} are accurately metered according to the formula, and then sprayed and coated on the outer surface thereof in a drum-type mixing granulator with the molten stearic acid prepared in step a, in order to form a coating film, as evenly as possible, on the outer surface of compound fertilizer granules, then dried by hot wind and cooled by wind at room temperature to afford coated granules for further steps; the process conditions are as follows:
the drying temperature of hot wind is not higher than 80° C.
the temperature of cooling airflow is not higher than 50° C.;
\textcircled{3}. secondary surface dusting of modified zeolite powder
a. preparation of mixed powder for dusting
according to the formula comprising 1.5%˜3.0% of magnesium stearate and 97%˜98.5% of zeolite powder, separate components used as raw materials are accurately weighed, well mixed, and ground into fine powder for further steps, making sure that the fine powder can pass through a sieve with a mesh size of 120;
b. dusting
the amount of the mixed powder prepared in step a is controlled in such a way that 10˜15 kg of mixed powder is used for the dusting on every 1000 kg of sulfur-based nitrogen potassium compound fertilizer granules;
\textcircled{4}. screening, metering, quality control, package after quality certification, and acquisition of environment-friendly slow-release sulfur-based nitrogen potassium compound fertilizer; the resulting product has an appearance of rounded granules and is free of any odor; the product meets the requirement of the following quality standards:

| | |
|---|---|
| Content of N element % | ≧18 |
| Content of K₂O % | ≧10 |
| Granule size mm | 2-4.75 mm |
| Moisture content wt % | ≦2.0 |

The environment-friendly slow-release sulfur-based nitrogen potassium compound fertilizer of the present disclosure is prepared by means of the following procedures: firstly, sulfur-based nitrogen potassium compound fertilizer granules are prepared, primary coating of stearic acid and secondary surface dusting of modified zeolite powder are then conducted on the sulfur-based nitrogen potassium compound fertilizer granules. The production process mainly include the mixing of molten urea, ammonium sulfate, and potassium potassium sulfate, as well as the granulation of various components of the compound fertilizer in traditional granulator, which is simple and beneficial for environmental protection, avoiding the deficiency of high investment cost of tower granulation apparatus.

The coating material, employed in the present disclosure, can be degraded with the action of microorganisms in soil, stearic acid is easily decomposed into CO₂ and H₂O with the action of microorganisms in soil, avoiding the environmental pollution caused by coating material, saving the fossil resources, and doing a favor for the ecological balance.

The sulfur-based compound fertilizer of the present application is of strong adaptability and wide scope of application to crops and soil, and thus can be used as basic fertilizer, additional fertilizer, seed fertilizer and foliage fertilizer. The sulfur-based compound fertilizer of the present application can effectively enhance both the yield of crops and the quality of agricultural products, overcoming the deficiencies existed in chlorine-based fertilizers.

The purpose of the present disclosure can also be achieved by the following solutions: An environment-friendly slow-release nitrogen potassium sulfur-based compound fertilizer of the present disclosure, characterized in that said sulfur-based nitrogen potassium compound fertilizer granules are made from the following raw materials in parts by weight:

| | |
|---|---|
| Urea | 35~50 |
| Ammonium sulfate | 10~20 |
| Potassium sulfate | 30~45 |
| Granulating adjuvant | 8~10 |
| Water | Q.S. |

it is a preferred technical solution.

An environment-friendly slow-release nitrogen potassium sulfur-based compound fertilizer of the present disclosure, characterized in that said sulfur-based nitrogen potassium compound fertilizer granules are made from the following raw materials in parts by weight:

| | |
|---|---|
| Urea | 45 |
| Ammonium sulfate | 12 |
| Potassium sulfate | 35 |
| Granulating adjuvant | 8 |
| Water | Q.S. |

it is a preferred technical solution.

The environment-friendly slow-release sulfur-based nitrogen potassium compound fertilizer of the present disclosure, characterized in that said preparation method comprises the following steps:

\textcircled{1}. preparation of sulfur-based nitrogen potassium compound fertilizer granules
firstly, 35˜50 parts by weight of urea is heated to a molten state, 10˜20 parts by weight of ammonium sulfate and 30˜45 parts by weight of potassium sulfate are added thereinto and well mixed, 8˜10 parts by weight of granulating adjuvant and appropriate amount of water are added thereinto, various components of the compound fertilizer are mixed and granulated by using conventional granulator to afford granules for further steps;
\textcircled{2}. primary coating of stearic acid
the amount of stearic acid accounts for 1.2% by weight of the sulfur-based nitrogen potassium compound fertilizer granules prepared in step \textcircled{1}, the coating process is as follows:
a. preparation of molten stearic acid
the stearic acid for coating is accurately metered according to the formula, added into melting bath for stearic acid, and heated to a molten state to afford molten stearic acid for further steps;
b. coating
the sulfur-based nitrogen potassium compound fertilizer granules prepared in step \textcircled{1} are accurately metered according to the formula, and then sprayed and coated on the outer surface thereof in a drum-type mixing granulator with the molten stearic acid prepared in step a, in order to form a coating film, as evenly as possible, on the outer surface of compound fertilizer granules, then dried by hot wind and cooled by wind at room temperature to afford coated granules for further steps; the process conditions are as follows:
the drying temperature of hot wind is 60° C.
the temperature of cooling airflow is 40° C.;
\textcircled{3}. secondary surface dusting of modified zeolite powder
a. preparation of mixed powder for dusting
according to the formula comprising 2.5% of magnesium stearate and 97.5% of zeolite powder, separate components used as raw materials are accurately weighed, well mixed, and ground into fine powder for further steps, making sure that the fine powder can pass through a sieve with a mesh size of 120;
b. dusting
the amount of the mixed powder prepared in step a is controlled in such a way that 10 kg of mixed powder is used for the dusting on every 1000 kg of sulfur-based nitrogen potassium compound fertilizer granules;

\textcircled{4}. screening, metering, quality control, package after quality certification, and acquisition of environment-friendly slow-release sulfur-based nitrogen potassium compound fertilizer; the resulting product has an appearance of rounded granules and is free of any odor;

such preparation method is a preferred technical solution.

Use of the environment-friendly slow-release sulfur-based nitrogen potassium present compound fertilizer of the present disclosure, characterized in that it is suitable for use as feed fertilizer, basic fertilizer and additional fertilizer for food crops, vegetables and fruit trees.

Use of the environment-friendly slow-release sulfur-based nitrogen potassium present compound fertilizer of the present disclosure, characterized in that it is applied together with various phosphate fertilizers or phosphate compound fertilizers which are commercially available in order to meet the demands of various crops and different soil conditions on nutrients like nitrogen, phosphorus, and potassium.

The environment-friendly slow-release sulfur-based nitrogen potassium compound fertilizer of the present disclosure, compared to the prior art, has positive effects as follows:

1. Provided is an environment-friendly slow-release sulfur-based nitrogen potassium compound fertilizer, which exhibits a good slow-release effect, high fertilizer availability, and a wide scope of application, whereas only needs a simple and low-cost producing process, the coating material of which is easily degraded by microorganisms in soil, and which is beneficial for the environmental protection of soil, air and water.
2. Single coating, simple producing process, low cost of apparatus and production.
3. The coating material can be degraded with the action of microorganisms in soil, avoiding soil pollution caused by the coating material.
4. The coating material employed can be degraded with the action of microorganisms in soil, stearic acid is easily decomposed into CO₂ and H₂O with the action of microorganisms in soil, avoiding the environmental pollution caused by coating material, saving the fossil resources, and doing a favor for the ecological balance.
5. The sulfur-based compound fertilizer is of strong adaptability and wide scope of application, and thus can be used as basic fertilizer, additional fertilizer, seed fertilizer and foliage fertilizer, effectively enhancing both the yield of crops and the quality of agricultural products, overcoming the deficiencies existed in chlorine-based fertilizers.
6. It can be applied in various ways, such as together with various phosphate fertilizers or phosphate compound fertilizers which are commercially available in order to meet the demands of various crops and different soil conditions on nutrients like nitrogen, phosphorus, and potassium.
7. It exhibits a good slow-release effect and high fertilizer availability, suitable for use as feed fertilizer, basic fertilizer and additional fertilizer for food crops, vegetables and fruit trees.
8. The environment-friendly slow-release sulfur-based nitrogen potassium compound fertilizer of the present disclosure can be applied in various ways and for a wide range of uses, such as together with various phosphate fertilizers or phosphate compound fertilizers which are commercially available. The percentage increase in average fertilizer availability is 11.1%˜19.3%; with respect to food crops, the percentage increase in average yield is 5.7%˜17.3%; with respect to fruit trees, vegetables and the like, the percentage increase in average yield is 13.1˜27.9%.

### DETAILED DESCRIPTION OF THE DISCLOSURE

Accompanying with the following examples, the present disclosure would be described in detailed hereinafter.

### Example 1

An environment-friendly slow-release sulfur-based nitrogen potassium compound fertilizer of the present disclosure is prepared in accordance with the following steps.

\textcircled{1}. preparation of sulfur-based nitrogen potassium compound fertilizer granules
firstly, 45 parts by weight of urea is heated to a molten state, 12 parts by weight of ammonium sulfate and 35 parts by weight of potassium sulfate are added thereinto and well mixed, 8 parts by weight of granulating adjuvant and appropriate amount of water are added thereinto, various components of the compound fertilizer are mixed and granulated by using conventional granulator to afford granules for further steps;
\textcircled{2}. primary coating of stearic acid
the amount of stearic acid accounts for 0.6%˜1.2% by weight of the sulfur-based nitrogen potassium compound fertilizer granules prepared in step \textcircled{1}, the coating process is as follows:
a. preparation of molten stearic acid
the stearic acid for coating is accurately metered according to the formula, added into melting bath for stearic acid, and heated to a molten state to afford molten stearic acid for further steps;
b. coating
the sulfur-based nitrogen potassium compound fertilizer granules prepared in step \textcircled{1} are accurately metered according to the formula, and then sprayed and coated on the outer surface thereof in a drum-type mixing granulator with the molten stearic acid prepared in step a, in order to form a coating film, as evenly as possible, on the outer surface of compound fertilizer granules, then dried by hot wind and cooled by wind at room temperature to afford coated granules for further steps; the process conditions are as follows:
the drying temperature of hot wind is not higher than 80° C. the temperature of cooling airflow is not higher than 50° C.;
\textcircled{3}. secondary surface dusting of modified zeolite powder
a. preparation of mixed powder for dusting
according to the formula comprising 1.5%˜3.0% of magnesium stearate and 97%˜98.5% of zeolite powder, separate components used as raw materials are accurately weighed, well mixed, and ground into fine powder for further steps, making sure that the fine powder can pass through a sieve with a mesh size of 120;
b. dusting
the amount of the mixed powder prepared in step a is controlled in such a way that 10˜15 kg of mixed powder is used for the dusting on every 1000 kg of sulfur-based nitrogen potassium compound fertilizer granules;
\textcircled{4}. screening, metering, quality control, package after quality certification, and acquisition of environment-friendly slow-release sulfur-based nitrogen potassium compound fertilizer; the resulting product has an appearance of rounded granules and is free of any odor; the product meets the requirement of the following quality standards:

| | |
|---|---|
| Content of N element % | ≧18 |
| Content of K₂O % | ≧10 |
| Granule size mm | 2~4.75 mm |
| Moisture content wt % | ≦2.0 |

### Example 2˜7

An environment-friendly slow-release sulfur-based nitrogen potassium compound fertilizer of the present disclosure is prepared in accordance with the formula in Table 1, according to the method and steps in Example 1.

TABLE 1

| Raw | Exam- | Exam- | Exam- | Exam- | Exam- | |
|---|---|---|---|---|---|---|
| material | ple 2 | ple 3 | ple 4 | ple 5 | ple 6 | Example 7 |
| Urea | 50 | 40 | 51 | 43 | 57 | 31 |
| Ammonium | 10 | 20 | 10 | 17 | 11 | 14 |
| sulfate | | | | | | |
| Potassium | 30 | 33 | 30 | 30 | 20 | 50 |
| sulfate | | | | | | |
| Granulating | 10 | 7 | 9 | 10 | 12 | 6 |
| adjuvant | | | | | | |
| Water | Q.S. | Q.S. | Q.S. | Q.S. | Q.S. | Q.S. |

The resulting products have an appearance of rounded granules and are free of any odor.

The product meets the requirement of the following quality standards:

| | |
|---|---|
| Content of N element % | ≧18 |
| Content of K₂O % | ≧10 |
| Granule size mm | 2~4.75 mm |
| Moisture content wt % | ≦2.0 |

All the environment-friendly slow-release sulfur-based nitrogen potassium compound fertilizers prepared in Example 1˜Example 7 are suitable for use as feed fertilizer, basic fertilizer and additional fertilizer for food crops, vegetables and fruit trees. They can also be applied together with various phosphate fertilizers or phosphate compound fertilizers which are commercially available. The percentage increase in average fertilizer availability is 11.1%˜19.3%; with respect to food crops, the percentage increase in average yield is 5.7%˜17.3%; with respect to fruit trees, vegetables and the like, the percentage increase in average yield is 13.1˜27.9%.

1. An environment-friendly slow-release nitrogen potassium sulfur-based compound fertilizer prepared by the following procedures:
i) preparing sulfur-based nitrogen potassium compound fertilizer granules,
ii) forming a primary coating of stearic acid on the sulfur-based nitrogen potassium compound fertilizer granules, and
iii) forming a secondary surface dusting of modified zeolite powder are then the coated sulfur-based nitrogen potassium compound fertilizer granules obtained in ii),
wherein said sulfur-based nitrogen potassium compound fertilizer granules are made from the following raw materials in parts by weight:

| | |
|---|---|
| urea | 31~57 |
| ammonium sulfate | 10~20 |
| potassium sulfate | 20~50 |
| granulating adjuvant | 6~12 |
| water | Q.S. |

wherein said granulating adjuvant is prepared by mixing 50%˜75% of bentonite and 50%˜25% of powdered bauxite;
wherein said stearic acid accounts for 0.6%˜1.2% by weight of the sulfur-based nitrogen potassium compound fertilizer granules obtained in i);
wherein said modified zeolite powder is composed of the following raw materials in parts by weight:

| | |
|---|---|
| magnesium stearate | 1.5%~.3.0% |
| zeolite powder | 97%~98.5% |

wherein:
\textcircled{1}. i) comprises:
a. heating 31˜57 parts by weight of urea to a molten state,
b. adding and mixing 10˜20 parts by weight of ammonium sulfate and 20˜50 parts by weight of potassium sulfate the molten urea to form a first mixture,
c. adding and mixing 6˜12 parts by weight of granulating adjuvant and water to the first mixture to form a second mixture, and
d. granulating the second mixture with a granulator to afford granules;
\textcircled{2}. ii) comprises:
a. adding stearic acid into a melting bath, and heating to a molten state to afford molten stearic acid;
b. spraying and coating an outer surface of the sulfur-based nitrogen potassium compound fertilizer granules prepared in step \textcircled{1} in a drum mixing granulator with the molten stearic acid prepared in step a, to form a coating film on the outer surface of the sulfur-based nitrogen potassium compound fertilizer granules, then c. drying with hot air and cooling by air at room temperature to afford the coated granules;
process conditions are as follows:
a drying temperature of hot air is not higher than 80° C.
a temperature of cooling airflow is not higher than 50° C.;
\textcircled{3}. iii) comprises:
a. preparing mixed powder by
mixing 1.5%˜3.0% of magnesium stearate and 97%˜98.5% of zeolite powder, and grinding into fine powder, the fine powder being capable of passing through a sieve with a mesh size of 120;
b. dusting
the mixed powder prepared in step a in such a way that 10˜15 kg of the mixed powder is used for dusting every 1000 kg of the sulfur-based nitrogen potassium compound fertilizer granules;
the procedures further comprise:
\textcircled{4}. screening, metering, quality control, package after quality certification, to afford environment-friendly slow-release sulfur-based nitrogen potassium compound fertilizer that comprises rounded granules and is free of any odor;
the fertilizer meets the following quality standards:

| | |
|---|---|
| content of N element % | ≧18 |
| content of K₂O % | ≧10 |
| granule size mm | 2-4.75 mm |
| moisture content wt % | ≦2.0 |

2. The environment-friendly slow-release sulfur-based nitrogen potassium compound fertilizer according to claim 1, wherein said sulfur-based nitrogen potassium compound fertilizer granules are made from the following raw materials in parts by weight:

| | |
|---|---|
| urea | 35~50 |
| ammonium sulfate | 10~20 |
| potassium sulfate | 30~45 |
| granulating adjuvant | 8~10 |
| water | Q.S. |

3. The environment-friendly slow-release sulfur-based nitrogen potassium compound fertilizer according to claim 1, wherein said sulfur-based nitrogen potassium compound fertilizer granules are made from the following raw materials in parts by weight:

| | |
|---|---|
| urea | 45 |
| ammonium sulfate | 12 |
| potassium sulfate | 35 |
| granulating adjuvant | 8 |
| water | Q.S. |

4. The environment-friendly slow-release sulfur-based nitrogen potassium compound fertilizer according to claim 1, wherein:
\textcircled{1}. i) comprises:
a. heating 35˜50 parts by weight of urea is h ted to a molten state, b. adding and mixing 10˜20 parts by weight of ammonium sulfate and 30˜45 parts by weight of potassium sulfate to the molten urea to form a first mixture,
c. adding and mixing 8˜10 parts by weight of granulating adjuvant and water to the first mixture to form a second mixture, and
d. granulating the second mixture with a conventional granulator to afford granules;
\textcircled{2}. ii) comprises:
adding stearic acid into a melting bath, and heating to a molten state to afford molten stearic acid, wherein stearic acid accounts for 1.2% by weight of the sulfur-based nitrogen potassium compound fertilizer granules prepared in step \textcircled{1};
b. spraying and coating an outer surface of
the sulfur-based nitrogen potassium compound fertilizer granules prepared in step \textcircled{1} in a drum mixing granulator with the molten stearic acid prepared in step a, to form a coating film on the outer surface of the sulfur-based nitrogen potassium compound fertilizer granules, then c. drying with hot air and cooling by air at room temperature to afford the coated granules;
process conditions are as follows:
a drying temperature of hot air is 60° C.
a temperature of cooling airflow is 40° C.;
\textcircled{3}. iii) comprises
a. preparing mixed powder by
mixing 2.5% of magnesium stearate and 97.5% of zeolite powder, and
grinding into fine powder, the fine powder being capable of passing through a sieve with a mesh size of 120;
b. dusting
the mixed powder prepared in step a in such a way that 10 kg of the mixed powder is used for dusting on every 1000 kg of the sulfur-based nitrogen potassium compound fertilizer granules;
the procedures further comprise:
\textcircled{4}. screening, metering, quality control, package after quality certification, to afford environment-friendly slow-release sulfur-based nitrogen potassium compound fertilizer;
that comprises rounded granules and is free of any odor.

5. The environment-friendly slow-release sulfur-based nitrogen potassium present compound fertilizer according to claim 1, the environment-friendly slow-release sulfur-based nitrogen potassium present compound fertilizer being a feed fertilizer, or a fertilizer for food crops, vegetables or fruit trees.

6. The environment-friendly slow-release sulfur-based nitrogen potassium present compound fertilizer according to claim 1, the environment-friendly slow-release sulfur-based nitrogen potassium present compound fertilizer further comprising a phosphate fertilizers or phosphate compound fertilizers.
